(19) United States
(12) Patent Application Publication
(10) Pub. No.: US 2018/0087688 A1
(43) Pub. Date: Mar. 29, 2018

(54) VALVE FOR PRESSURIZED FLUID AND BOTTLE COMPRISING SUCH A VALVE

(71) Applicant: L'Air Liquide, Société Anonyme pour l'Etude et l'Exploitation des Procédés Georges Claude, Paris (FR)

(72) Inventors: Antoine FRENAL, Evanville (FR); Patrick BACOT, Meudon (FR); Benjamin FISCHER, L'Hay-les-Roses (FR)

(21) Appl. No.: 15/711,071

(22) Filed: Sep. 21, 2017

(30) Foreign Application Priority Data
Sep. 26, 2016 (FR) 1659019

(51) Int. Cl. F16K 37/00; F17C 7/00; F17C 13/04; F16K 31/60; F16K 31/02

(52) U.S. Cl. CPC F16K 37/0025; F17C 7/00; F16K 31/02; F16K 31/602; F17C 13/04

(57) ABSTRACT

Valve for pressurized fluid including a body housing a fluid circuit having an upstream end and a downstream end, the circuit including a member for controlling the flow rate in the circuit, the member for controlling the flow rate being commanded by an actuating member, the actuating member being mounted in a mobile manner on the body of the valve between a rest position and an active position, the valve including at least one electronic functional member and a circuit breaker for commanding the electronic functional member, wherein the circuit breaker can be moved into at least two separate states, wherein the actuating member is configured to move the circuit breaker from a first state towards a second state during the movement thereof into at least one of the following positions: the rest position thereof, the active position thereof, or an intermediate position between these two positions.

### CROSS REFERENCE TO RELATED APPLICATIONS

This application claims the benefit of priority under 35 U.S.C. § 119 (a) and (b) to French Patent Application No. 1659019, filed Sep. 26, 2016, the entire contents of which are incorporated herein by reference.

### BACKGROUND

The invention relates to a valve for pressurized fluid and a reservoir comprising such a valve.

### SUMMARY

The invention relates more particularly to a valve for pressurized fluid, with or without an incorporated pressure relief device, comprising a body housing a fluid circuit having an upstream end intended to be connected to a pressurized fluid reserve and a downstream end intended to be connected to a receiving apparatus, the circuit comprising a member for controlling the flow rate in the circuit, the member for controlling the flow rate being commanded by an actuating member mobile with respect to the body of the valve, the actuating member being mounted in a mobile manner on the body of the valve between a rest position in which the control member is arranged in a first state corresponding to a first value for flow rate in the circuit and an active second position in which the actuating member moves the control member into a second state corresponding to a second value for flow rate in the circuit, the valve comprising at least one electronic functional member and a circuit breaker for commanding the at least one electronic functional member, wherein the circuit breaker can be moved into at least two separate states.

In order to improve the functionalities of a valve for a pressurized fluid bottle or bottles, it is known to provide electronic members for measuring and/or for communicating wirelessly.

Reference should be made, for example, to the document FR2868160A1 which describes a modular system incorporating an electronic sensor for measuring the autonomy of a pressurized gas reservoir.

Adjusting the electronic functionalities of such valves requires the provision of mechanical and electronic elements which meet the requirements of reliability, safety and smooth operation. The electrical and mechanical links between various electronic members must, particularly, fulfil these constraints.

Moreover, an important constraint of these devices is the electrical consumption thereof which determines the autonomy thereof.

An aim of the present invention is to overcome all or some of the disadvantages of the prior art which have been set out above.

To this end, the valve according to the invention, moreover in accordance with the generic definition thereof given in the preamble above, is mainly characterized in that the actuating member is configured to move the circuit breaker from a first state towards a second state during the movement thereof into at least one of the following positions: the rest position thereof, the active position thereof, or an intermediate position between these two positions.

“Circuit breaker” refers to a member cooperating with an electrical or electronic circuit having at least two separate states (for example activated or unactivated) which can be processed by a controller in order to optionally activate some functions. For example, the circuit breaker can be any type of switch.

Moreover, embodiments of the invention can include one or more of the following features:
the actuating member moves or switches the circuit breaker by magnetic and/or mechanical and/or electrical and/or pneumatic and/or hydraulic actuation,
the circuit breaker is a magnetic circuit breaker, the actuating member comprising a magnetic element that generates a magnetic field and moves the circuit breaker without contact via the magnetic field thereof,
the control member comprises at least one of the following: an isolation flap, a flow rate or pressure regulator gate, a mobile flap-pusher member for actuating a flap of another apparatus to which the valve is intended to be connected,
the actuating member comprises a lever pivotably mounted on the body of the valve,
the at least one electronic functional member comprises at least one of the following: a device for receiving and/or transmitting data wirelessly comprising an antenna, a pressure and/or temperature sensor, an electronic logic for storing and processing data comprising a microprocessor, a digital screen, and a light source,
the circuit breaker can be moved between two open and closed separate states, respectively, corresponding to opening or closing, respectively, an electrical circuit comprising the at least one electronic functional member,
the two open and closed states of the circuit breaker command the interruption of the electrical power supply and the electrical power supply, respectively, to the at least one electronic functional member,
the at least one electronic functional member is arranged in a casing removably mounted on the body of the valve,
the valve comprises a mounting end comprising catching members intended to engage catching complementary members in order to form a system for rapid connection of the valve on another valve or on a fluid circuit.

The invention also relates to a pressurized fluid bottle comprising a valve according to any one of the features above or below.

The invention can also relate to any alternative device or method comprising any combination of the features above or below.

### BRIEF DESCRIPTION OF THE DRAWINGS

Other characteristic features and advantages will emerge upon reading the following description, with reference to the figures wherein:

FIG. 1 shows a partial and schematic sectional view illustrating a valve structure in a first operating configuration, in accordance with one embodiment of the present invention,

FIG. 2 shows a partial and schematic sectional view illustrating the valve of FIG. 1 in a second operating configuration, in accordance with one embodiment of the present invention,

FIG. 3 shows a partial and schematic sectional view illustrating another valve structure mounted on a reservoir, in accordance with one embodiment of the present invention,

FIG. 4 shows a partial and schematic enlarged sectional view of a detail of a valve illustrating an example of a mechanism for actuating a circuit breaker in a first state, in accordance with one embodiment of the present invention,

FIG. 5 shows a partial and schematic enlarged sectional view of a detail of a valve illustrating an example of a mechanism for actuating a circuit breaker in a second state, in accordance with one embodiment of the present invention,

FIG. 6 shows a partial and schematic enlarged sectional view of a detail of a valve illustrating another exemplary embodiment of a mechanism for actuating a switch according to the invention.

### DESCRIPTION OF PREFERRED EMBODIMENTS

The valve 1 shown in the figures comprises a body 2 conventionally housing a fluid circuit 3 having an upstream end 4 intended to be connected to a pressurized fluid reserve (a bottle 14 or a set of bottles for example) and a downstream end 5 intended to be connected to an apparatus using the gas provided by the pressurized fluid reserve.

As illustrated in FIG. 3, the circuit 3 can conventionally comprise a gate 6 for controlling the flow rate in the circuit 3. This gate 6 can be an isolation flap for opening and closing the circuit 3 and/or a flap for setting a flow rate or a pressure or any other type of appropriate flap.

The gate 6 is commanded by a lever 7 pivotably mounted on the body 2 of the valve 1 (at, for example, at least one hinge 15).

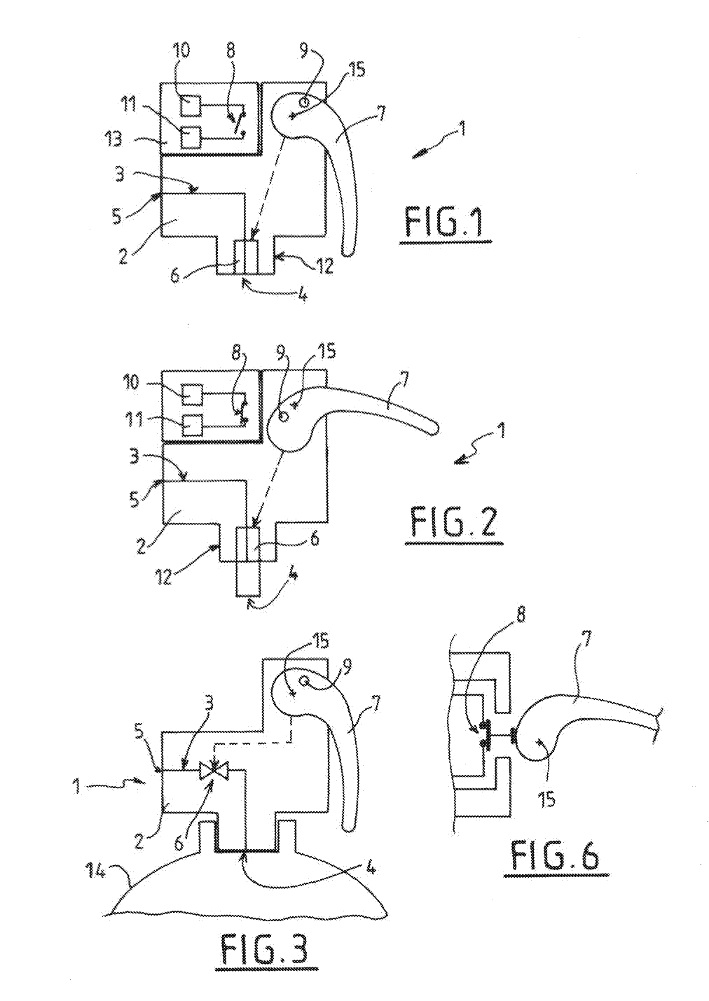

The lever 7 is mobile between a rest position (see, for example, FIG. 3 or FIG. 1) in which the gate 6 is kept in a first state corresponding to a first value for flow rate in the circuit 3 (for example a zero flow rate) and an active second position (see FIG. 2 which relates to a close embodiment) in which the lever 7 moves the gate 6 into a second state corresponding to a second value for flow rate in the circuit 3 (for example circuit completely open for a maximum flow rate).

As shown in the diagram of FIG. 3, the valve 1 can be connected (fixed, for example, by screwing via catching members 12) to a pressurized fluid bottle.

The member 6 for controlling flow rate in the circuit 3 shown in FIG. 3 comprises a gate 6, but any other member 6 for controlling flow rate could be envisaged.

For example, alternatively or in combination, and as illustrated in FIGS. 1 and 2, the valve 2 could comprise a mobile piece such as a flap-pusher, the movement of which is commanded by the lever 7. This flap-pusher 6, which is, for example translatable, can be provided, for example, to actuate (in particular open) a system of a flap or flaps which is located on another valve or a bottle on which the valve 1 is connected in order to draw or transfer pressurized fluid.

For example, this valve 1 could be connectable (via the catching members 12), in a removable manner, to another separate valve called a “base valve”. This base valve is, for example, rigidly connected to at least one pressurized fluid bottle. In this case, the flap-pusher 6, the movement of which is commanded by the lever 7, can command the opening or closing of an isolation flap of the base valve on which said valve 1 is connected in a removable manner.

Likewise, the pivoting lever 7 can be replaced by any other appropriate actuating member (button, that can be translated and/or rotated), etc.

The valve 1 further comprises at least one electronic functional member 10, 11 and a circuit breaker 8 for commanding the at least one electronic functional member 10, 11.

The circuit breaker 8 can be moved into at least two separate states, for example “open” and “closed” corresponding, for example, to the absence or the presence of a supply of power to the electronic functional member 10, 11. Likewise, these two states of the circuit breaker can correspond to two separate operating states of the electronic functional member 10, 11 having separate electrical consumptions (“standby state” and “active state” or two distinct levels of electrical power).

According to an advantageous characteristic feature, the actuating member 7 is configured to move the circuit breaker 8 between two separate states when it is moved into at least one of the following positions: the rest position thereof, the rest position thereof, or an intermediate position between these two positions.

This means that when the actuating member 7 is moved from a first starting position (rest position, active position, or an intermediate position between these two positions) towards a second separate position (active position, rest position or an intermediate position between these two positions), the circuit breaker 8 is moved or switched from a first state to a second state. Preferably, the reverse movement (return to the starting position) commands the reverse switching.

Therefore, the movement of the lever 7 commands both the fluid circuit and the electrical circuit. For example, one or more members of the electronic functional member 10, 11 are switched off or switched on or activated or modified depending on whether the lever 7 triggers a transfer of fluid in the circuit 3, or not.

This makes it possible to adjust the operation and/or the electrical consumption of the electronic functional member(s) 10, 11 to the fluid operation of the valve. This improves the ergonomics of use of the valve, the operation thereof and the electrical consumption thereof.

In a simple case, the electronic functional member 10, 11 (a wireless communication antenna or another component) is switched off when the fluid circuit is closed and switched on when the circuit is open. Of course, other more advanced configurations are possible. For example, the measuring frequency of an electronic sensor or the data transfer frequency of a communication member is modified (increased) when the circuit is open and vice versa.

The electronic functional member(s) 10, 11 can comprise at least one of the following: a device for receiving and/or transmitting data wirelessly comprising an antenna, a pressure sensor, a temperature sensor, an electronic logic for storing and processing data comprising a microprocessor, a digital screen, a light source, etc.

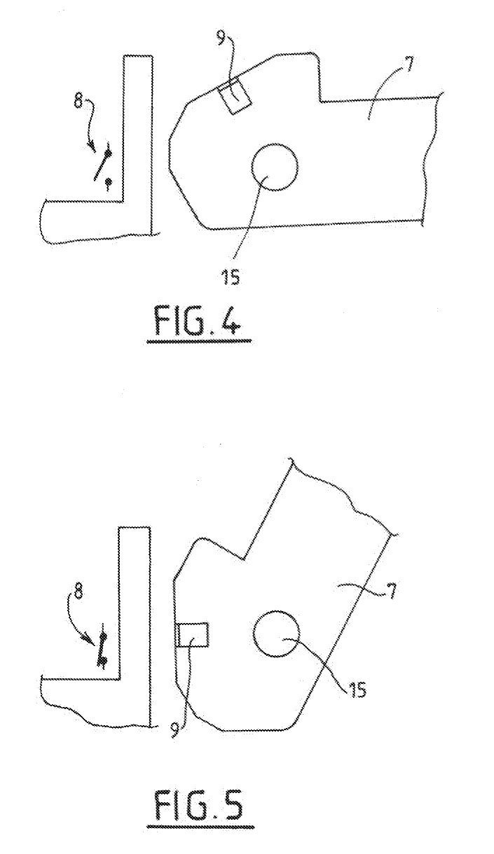

In the example of FIGS. 1-5, a circuit breaker 8 is a magnetic circuit breaker and the lever 7 comprises a magnetic element 9 (such as a permanent magnet) that generates a magnetic field and moves the circuit breaker 8 without contact via the magnetic field thereof. For example, the circuit breaker 8 is urged into the closed position in the absence of a magnetic field of the magnet (or below a level of intensity of the magnetic field), see FIGS. 1 and 4. The circuit breaker 8 is, by contrast, switched into the open position when the magnetic element 9 is brought closer (see FIGS. 2 and 5).

Of course, in an alternative, the lever 7 could move the circuit breaker 8 by mechanical and/or electrical and/or pneumatic and/or hydraulic actuation (see FIG. 6 for example).

As shown in the diagrams of the figures, the at least one electronic functional member 10, 11 can be accommodated in a casing 13 removably mounted on the body 2 of the valve 1.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A valve for pressurized fluid, comprising a body housing a fluid circuit having an upstream end configured to be connected to a pressurized fluid reserve and a downstream end configured to be connected to a receiving apparatus, the fluid circuit comprising a member for controlling the flow rate in the fluid circuit, the member for controlling the flow rate being commanded by an actuating member, mobile with respect to the body housing, the actuating member being mounted in a mobile manner on the body housing between a rest position in which the control member is arranged in a first state corresponding to a first value for flow rate in the fluid circuit and an active second position in which the actuating member moves the control member into a second state corresponding to a second value for flow rate in the fluid circuit, the valve comprising at least one electronic functional member and a circuit breaker for commanding the at least one electronic functional member, wherein the circuit breaker can be moved into at least two separate states, the actuating member being configured to move the circuit breaker from a first state towards a second state during the movement thereof into at least one of the following positions: the rest position thereof, the active position thereof, or an intermediate position between these two positions, wherein the actuating member comprises a lever pivotably mounted on the body housing and in that the circuit breaker is separate and at a distance from the control member.

2. The valve of claim 1, wherein the lever is pivotably mounted on the body housing at an end comprising at least one hinge and in that said end of the lever comprises a lug, a portion of which moves the circuit breaker depending on the position of the lever on the body housing.

3. The valve of claim 1, wherein the circuit breaker is magnetic and wherein the lever comprises a magnetic element such as a permanent magnet generating a magnetic field that moves the circuit breaker without contact via the magnetic field thereof depending on the position of the lever on the body housing.

4. The valve of claim 3, wherein the magnetic element is accommodated in a cavity of the lever.

5. The valve of claim 1, wherein the actuating member moves or switches the circuit breaker by magnetic and/or mechanic and/or electrical and/or pneumatic and/or hydraulic actuation.

6. The valve of claim 1, wherein the circuit breaker is a magnetic circuit breaker and in that the actuating member comprises a magnetic element that generates a magnetic field and moves the circuit breaker without contact via the magnetic field thereof.

7. The valve of claim 1, wherein the control member comprises at least one of the following: an isolation flap, a flow rate or pressure regulator gate, a mobile flap-pusher member for actuating a flap of another apparatus to which the valve is intended to be connected.

8. The valve of claim 1, wherein the at least one electronic functional member comprises at least one of the following: a device for receiving and/or transmitting data wirelessly comprising an antenna, a pressure and/or temperature sensor, an electronic logic for storing and processing data comprising a microprocessor, a digital screen, and a light source.

9. The valve of claim 1, wherein the circuit breaker can be moved between two open and closed separate states, corresponding to opening or closing an electrical fluid circuit comprising the at least one electronic functional member.

10. The valve of claim 9, wherein the two open and closed states of the circuit breaker command the interruption of the electrical power supply and the electrical power supply to the at least one electronic functional member.

11. The valve of claim 1, wherein the at least one electronic functional member is arranged in a casing removably mounted on the body housing.

12. The valve of claim 1, further comprising a mounting end comprising catching members intended to engage catching complementary members in order to form a system for rapid connection of the valve on another valve or on a fluid circuit.

13. A pressurized fluid bottle comprising a valve of claim 1.
